(19) United States
(12) Patent Application Publication
(10) Pub. No.: US 2020/0376362 A1
(43) Pub. Date: Dec. 3, 2020

(54) METHOD FOR REPRODUCING A PATTERN TO BE MARKED ON A GRASSED AREA

(71) Applicant: NATURAL GRASS, Paris (FR)

(72) Inventors: Bertrand PICARD, Paris (FR); Edmond-Pierre PICARD, Saint Sulpice de Favieres (FR)

(73) Assignee: NATURAL GRASS, Paris (FR)

(21) Appl. No.: 16/969,842

(22) PCT Filed: Feb. 19, 2019
(86) PCT No.: PCT/FR2019/050374

§ 371 Date: Aug. 13, 2020

(30) Foreign Application Priority Data
Feb. 21, 2018 (FR) 1851474

(51) Int. Cl. A63C 19/06; B41M 5/00; B41J 3/28; B41J 3/407

(52) U.S. Cl. CPC A63C 19/065; B41M 5/0041; A63C 2019/067; B41J 3/407; B41J 3/28

(57) ABSTRACT

A local coordinate system in which the turfed area is digitized, and a marking area is divided into elementary cells to form a matrix, and the pattern to be marked is broken down into a mosaic of pixels associated with the elementary cells of the matrix. Next, for each elementary cell of the matrix, tasks to be performed by the marking devices are determined according to a value of the pixel associated with said elementary cell, to mark the pattern to be marked on the marking area; and the movement of the vehicle over the turfed area is controlled so as to cover all of the elementary cells, and the marking devices are controlled so as to perform the tasks to be performed in each elementary cell.

The present invention relates to a method for reproducing an image on a turfed area, such as a natural-grass playing field in a stadium, on a racecourse, a golf course, etc.

Methods and devices for making such markings on a turfed area already exist.

Thus, document WO-200228541-A describes a mobile device comprising a marking head provided with nozzles and electronic means which control these nozzles according to the position of this mobile device at a given time, in accordance with the pattern to be reproduced. The position of the vehicle on the surface is tracked, and the nozzles controlled, by a global positioning system (GPS) after the coordinates of the surfaces to be marked have been entered.

Such a device may only be implemented if the satellite links with the vehicle are satisfactory. However, this is not the case for a vehicle placed on a field surrounded by stands, as these hinder the proper functioning of the GPS (“Global Positioning System”).

Document US-20120253613-A describes a method and a device for creating visual effects on a turfed area. High-resolution images are marked on lawns and fields using a global positioning system, a processor to generate the desired pattern which is translated into printing instructions, and a modeling tool which is used to generate detailed patterns and to mark these patterns on a lawn, a natural or artificial field, or more generally on a turfed area.

These known methods and devices allow a pattern to be reproduced on a turfed area which is approximately flat or appears to be so from a distance, such as a stadium field. However, with these methods and devices, an observer in the stadium will see the pattern from a certain angle which causes this image to be distorted. The same will be true in the case of a television camera: the image that will appear will be distorted and will not perfectly reflect the logo, typography, design or pattern desired.

Likewise, the altimetric shape z(x, y) of the turfed surface at the level of the marking area will have a more or less substantial image distortion effect, which may be relatively marginal for the shape of a stadium field (like a roof, single-pitch roof, etc.) but which may be significant in the case of a golf fairway.

In addition, as indicated above, the use of a GPS system to guide the vehicle and control the marking means is not possible for turfed surfaces surrounded by stands, such as large international stadia.

In addition, with a view to patterns such as brand logos to be produced repeatedly in a large number of stadia, potentially remote and different from one another, and, simultaneously, in the context of a sports competition for example, it is necessary for these patterns to be produced in a fast, repeatable, reliable and precise manner. The pattern therefore has to be produced in particular in the right place on the field, at the right scale, and so as to take into account the specificities of the stadium (size and slopes of the field, location of the cameras, plant varieties constituting the turf, etc.) However, the known methods and devices do not allow markings to be produced in such a way in a simple, fast, reliable, automated and autonomous manner. There is a lack of a method incorporating all of the means and steps for producing markings in such a way, starting with the definition of the parameters needed to obtain the same desired visual result for the marks, in an identical manner for each match or sport-peripheral event, despite the specificities of each stadium.

There is a known method used at the present time to simultaneously take into account the distortion due to the altimetric shape of the field and to the precise point of observation of the image while scaling and siting the image correctly.

Thus, document FR-2785230-A describes a method consisting in projecting the image to be reproduced on the area of the ground on which it is intended to reproduce this image, by means of a light projection means positioned at the exact location of the observation point intended for the camera. The advantage of the method is that the projected image is spontaneously deformed into anamorphosis; if this projected image were painted on the ground in the same pattern, it would naturally be seen from the observation point with the shape of the image initially projected, simply because the projection rays or light rays emitted from the image projected or marked on the field follow exactly the same rectilinear paths between the projected image and the camera or projector.

This prior method also includes forming the “characteristic contours” of the pattern on the ground, which should then serve as guides for the application of marking means. However, this method has substantial limits. In addition to the fact that such a method requires, prior to marking, a night-time projection of an outline and the identification of characteristic contours on the field, if present, most importantly this method does not in any way provide the marking instructions according to the position of the vehicle: indeed, it only makes it possible to visually follow an outline identified by guides positioned on the field, contrary to the desire according to the invention to automate the method in a single step according to a real-time measurement of the position of the vehicle, independently of its path.

The present invention has, on the contrary, the objective of providing a method for reproducing a pattern on a turfed area by means of a device comprising a vehicle provided with marking means, which makes it possible to control these marking means according to the position of the vehicle rather than by requiring the vehicle to visually follow one or more paths previously set out on the ground during a night-time projection of the image.

Therefore, one of the objects of the present invention is to provide a method for reproducing a pattern on a turfed area by means of a device comprising a vehicle provided with marking means, which makes it possible to control the marking means without having to use a global positioning system. Optionally, this method will also make it possible to guide this vehicle.

Another object is to provide a method that makes it possible to compensate for the optical distortions created by the shape of the field and the location of the cameras, which vary according to the stadium.

These objects, as well as others which will become apparent later, are achieved by means of a method for reproducing a pattern to be marked on a large-sized turfed area using a vehicle comprising a set of marking means, which method is, according to the present invention, characterized in that it comprises the following steps:
defining an orthonormal local coordinate system (0; x, y, z), the two axes (Ox, Oy) being in the horizontal plane, the axis (Oz) being the vertical axis and the point of origin (O) being located on or near the turfed area;
determining the predefined size (dx, dy) of the elementary cells along the first axis (Ox) and the second axis (Oy), respectively, of the local coordinate system, compatible with the size and the movement capability of the marking means so that said marking means are able to uniformly perform the marking of an elementary cell of dimension dx along the axis Ox and dy along the axis Oy without encroaching on the neighboring cells;
delimiting, on the turfed area, a marking rectangle parallel to said axes (Ox, Oy) of the coordinate system and defined by its limit coordinates between x₁ and x₂, and between y₁ and y₂, and in which said pattern will be reproduced at the desired scale on the turf and inscribed in said rectangle, reaching, without going beyond, the two sides of the rectangle parallel to the axis Oy of the coordinate system at the respective dimensions x₁ and x₂, and a first side of the rectangle parallel to the axis Ox at the dimension y₁, the dimension y₂ of the second side of the rectangle parallel to the axis Ox being calculated according to the height-to-width ratio of the pattern to be reproduced and such that, on the one hand, the length Y=y₂−y₁ of the sides parallel to the axis Oy of said rectangle is a multiple of dy and that, on the other hand, said pattern, if it were reproduced with the exact height-to-width ratio of the pattern to be reproduced, would have a length Y=y₂−y₁ +r with r smaller than dy;
adjusting the height-to-width ratio of the pattern to be reproduced by disregarding the remainder r calculated previously so that the adjusted image fits exactly in the marking rectangle of surface X. Y calculated in the preceding step, the distortion due to the adjustment being very low insofar as r is smaller than dy and as dy is itself very small with respect to the height Y=y₂−y₁ of the rectangle;
partitioning the marking rectangle into a juxtaposition of elementary cells of size dx along the axis Ox and dy along the axis Oy of the local coordinate system, said elementary cells being arranged in the form of rows and columns constituting a matrix;
for each marking means, breaking the pattern to be marked down into a mosaic of pixels associated with the elementary cells of the matrix;
determining, for each elementary cell of the matrix, the task to be performed by each marking means of the set of marking means according to the value of the pixel associated with said elementary cell for the marking means in question;
moving the vehicle over the turfed area along a path allowing all of the elementary cells to be covered;
determining, in real time and in the local coordinate system, the position and orientation of the vehicle as it moves over the turf, by means of a locating device and controlling the marking means according to the measured position and orientation of the vehicle so as to continually adjust the operation of the marking means according to the tasks to be performed in each elementary cell of the matrix and perform said tasks to be performed in each elementary cell in the matrix.

Preferably, the method comprises the following additional steps:
having a device for automatically controlling the vehicle and controlling it according to the measurement of the position and orientation of the vehicle so as to continually adjust the path in order to cover the marking rectangle parallel either to the axis Ox or to the axis Oy;
checking that all of the elementary cells of the matrix have been treated;
for as long as all of the elementary cells of the matrix (M) have not been treated, controlling the vehicle to move it over the marking area.

Advantageously, the point of origin (O) of the local coordinate system is located on or near the marking area.

According to a preferred embodiment of the present invention, the method further comprises the following steps:
determining the coordinates (X_{A}, Y_{A}, Z_{A}) of a target observation point (A) in the defined local coordinate system, which includes three axes;
selecting a planar source pattern;
determining the pattern to be marked according to the source pattern in order to compensate for a distortion due to the relative position of the target observation point with respect to the marking area, such that an image of the pattern to be marked viewed from said target observation point is substantially identical to an image of the source pattern which would be laid flat at turf level but on a tangent horizontal plane and the vertical projection of which on the turf would correspond to the limits of the marking area and which would be viewed from a source observation point located vertically in line with the center of the marking area, and preferably at a height from which the complete image is viewed at approximately the same solid angle as from said target observation point.
1. In the above application, the altimetric shape of the turfed area is ignored and need not be determined.
2. According to another preferred embodiment, in order to obtain an even more precise result and making it possible in particular to take account of the altimetric form z(x, y), the pattern to be marked in order to compensate for a distortion due to the relative position of the target observation point with respect to the marking area and to the altimetric shape z(x, y) of the turf surface is calculated on the basis of the source pattern such that the image marked on the field is exactly the same as that obtained by projecting the source pattern on the marking area using a light projection means positioned at the exact location of the target observation point.

According to this preferred embodiment of the present invention, the method therefore comprises the following additional steps:
determining the coordinates (X_{A}, Y_{A}, Z_{A}) of a target observation point (A) in the defined local coordinate system, which includes three axes;
determining the altimetric shape z(x, y) of the turfed surface of the marking area;
selecting a planar source pattern;
calculating the pattern to be marked according to the source pattern in order to compensate for a distortion due to the relative position of the target observation point with respect to the marking area and to the altimetric shape z(x, y) of the turfed surface, such that this image of the pattern to be marked on the field is the same as that obtained by projecting the source pattern on the marking area using a light projection means positioned at the location of the target observation point.

In a less precise but particularly practical way, the method according to the invention described above comprises simple parametric calculations in which the altimetric curve z(x, y) is replaced by various preset parametric curves z′(x, y): by default by a constant horizontal plane z=0 at the level of the turf or by a roof shape described by the coordinates of the ridge (by default the median longitudinal axis) and the pitch of the roof as %, or by a single pitch described by its pitch as % and its pitch line.

Advantageously, the method further comprises the step of determining the position and orientation of the vehicle in the local coordinate system by means of an optical telemetry device including a laser source emitting from the point of origin (O) of the local coordinate system and a reflecting tracking prism located on the vehicle.

Preferably, the marking means consist of compressed air nozzles that make it possible to bend the leaves or blades of grass in one direction or another, and of rollers, arranged after these nozzles in the direction of travel of the vehicle (V), to fix the orientation of the leaves or blades of grass.

The following description, which is in no way limiting, of one exemplary embodiment of the present invention should be read with reference to the appended figures, which show:

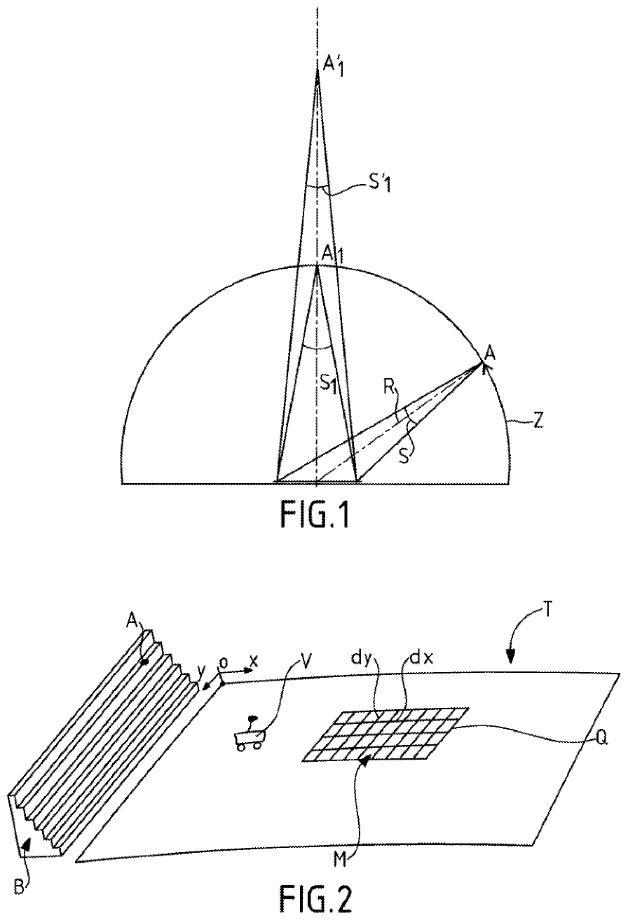

In FIG. 1, a method for compensating for image distortion.

In FIG. 2, an automatic marking system in which the method of the invention may be implemented.

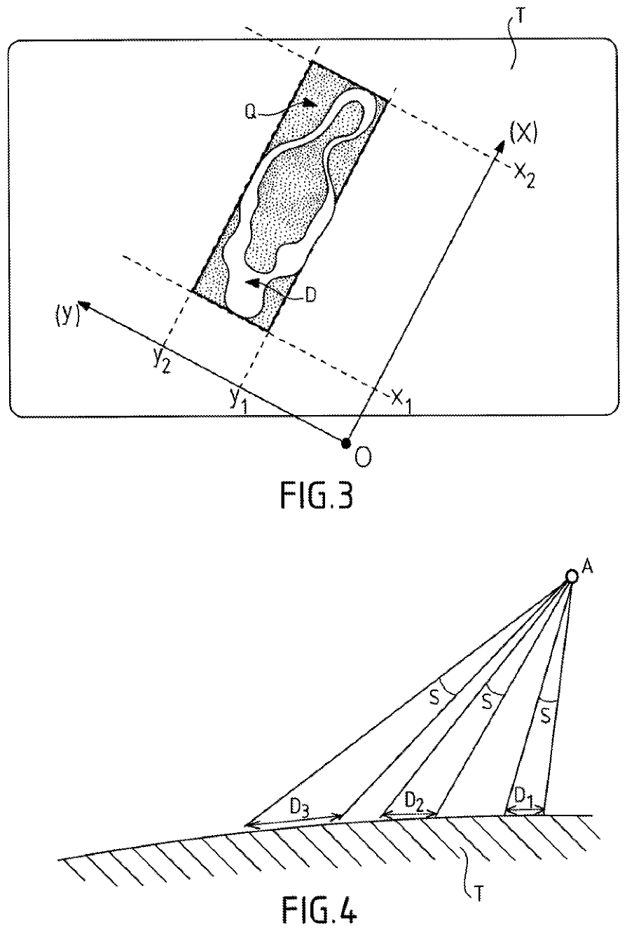

In FIG. 3, a schematic view of a turfed area with a marking area and a pattern in this latter area.

In FIG. 4, a diagram showing the view of three images of the same source pattern viewed from the same target observation point.

The present invention relates to a method for reproducing, in a rectangle of a turfed area, such as the natural-grass surface of a playing field, a large-sized pattern such as, for example, an advertising pattern. This reproduction or marking is performed by means of a vehicle (V) comprising in particular a set of marking means, and comprises the following steps:
a) defining an orthonormal local coordinate system (0; x, y, z), the two axes (Ox, Oy) being in the horizontal plane, the axis (Oz) being the vertical axis and the point of origin (O) being located on or near the turfed area (T);
b) determining the predefined size (dx, dy) of the elementary cells along the first axis (Ox) and the second axis (Oy), respectively, of the local coordinate system, compatible with the size and the movement capability of the marking means so that said marking means are able to uniformly perform the marking of an elementary cell of dimension dx along the axis Ox and dy along the axis Oy without encroaching on the neighboring cells;
c) delimiting, on the turfed area (T), a marking rectangle (Q) parallel to said axes (Ox, Oy) of the coordinate system and defined by its limit coordinates between x₁ and x₂, and between y₁ and y₂, and in which said pattern will be reproduced at the desired scale on the turf and inscribed in said rectangle (Q), reaching, without going beyond, the two sides of the rectangle parallel to the axis Oy of the coordinate system at the respective dimensions x₁ and x₂, and a first side of the rectangle parallel to the axis Ox at the dimension y₁, the dimension y₂ of the second side of the rectangle parallel to the axis Ox being calculated according to the height-to-width ratio of the pattern to be reproduced and such that, on the one hand, the length Y=y₂−y₁ of the sides parallel to Oy of said rectangle is a multiple of dy and that, on the other hand, said pattern, if it were reproduced with the exact height-to-width ratio of the pattern to be reproduced, would have a height Y=y₂−y₁+r with r smaller than dy;
d) adjusting the height-to-width ratio of the pattern to be reproduced by disregarding the remainder r calculated previously so that the adjusted image fits exactly in the marking rectangle (Q) of surface X. Y calculated in the preceding step, the distortion due to the adjustment being very low insofar as r is smaller than dy and as dy is itself very small with respect to the height Y=y₂−y₁ of the rectangle;
e) partitioning the marking rectangle (Q) into a juxtaposition of elementary cells of size dx along the axis Ox and dy along the axis Oy of the local coordinate system, said elementary cells being arranged in the form of rows and columns constituting a matrix (M);
f) for each marking means, breaking the pattern to be marked down into a mosaic of pixels associated with the elementary cells of the matrix (M);
g) determining, for each elementary cell of the matrix, the task to be performed by each marking means of the set of marking means according to the value of the pixel associated with said elementary cell for the marking means in question;
h) moving the vehicle (V) over the turfed area along a path allowing all of the elementary cells to be covered;
i) determining, in real time and in the local coordinate system, the position and orientation of the vehicle (V) as it moves over the turf, by means of a locating device and controlling each marking means according to the measured position and orientation of the vehicle so as to continually adjust the operation of the marking means according to the tasks to be performed in each elementary cell of the matrix (M) and perform said tasks to be performed in each elementary cell in the matrix (M).

In addition, the turfed surface may be digitized with respect to this local coordinate system: this digitization may concern all of the fields on which patterns are likely to be marked, thus allowing a fast, precise and reproducible operation.

According to this method, the fact of being able to digitize all of the playing fields on which patterns might be marked with respect to a local coordinate system specific to each field affords the method great freedom of implementation.

This method may include the following additional steps:
having a device for automatically controlling the vehicle (V) and controlling it according to the measurement of the position and orientation of the vehicle so as to continually adjust the path in order to cover the marking rectangle parallel either to the axis Ox or to the axis Oy;
checking that all of the elementary cells of the matrix have been treated;
for as long as all of the elementary cells of the matrix (M) have not been treated, controlling the vehicle to move it over the marking area.

This method also makes it possible to make a marked pattern (D) visible from a predetermined observation point (A) without distortion: that is to say that an observer located at this observation point (A) will see the pattern as if they were positioned perpendicular to the plane of that pattern. This observer may be, for example, a television camera.

As shown in FIG. 1, the observer located at the observation point (A) and at a distance (R) from the pattern (D) marked on the field views this pattern (D) at a solid angle (S): this results in a distorted view of the pattern (D).

It should be noted that the solid angle (S) decreases as the point (A) moves from the point (A1) located vertically from the pattern (D) towards the plane of the field.

Likewise, if the point (A1) is moved along a vertical to the pattern (D) away from this pattern (D), the solid angle (S1) at which this pattern (D) is viewed decreases. Thus, when the point (A1) is at the distance (R) from the pattern (D), the solid angle (S1) is larger than the solid angle (S′1) for an observation point (A′1) located on the same vertical as the point (A1) but at a distance greater than the distance (R).

To calculate the distortion to which to subject the pattern (D) so as to be seen by an observer located at the point (A) as if this observer were located vertically in line with the pattern (D), it is therefore necessary to know the dimensions of the pattern (D), the distance (R) at which the point (A) is located from the pattern (D) and the zenith angle (Z) for the point (A): thus three parameters are needed to determine how the observer located at the point (A) sees the pattern (D). However, it is also necessary to determine at which solid angle (S1) it is desired to view the pattern (D). Once these four parameters have been determined, it is possible to calculate the distorted image of the pattern (D) to be marked in order to compensate for the distortion due to the relative position of the observation point (A) with respect to the quadrangle in which this distorted image will be marked.

FIG. 2 schematically shows an automatic marking system in which this method may be implemented and FIG. 3 schematically shows the portion of turfed field comprising the marking rectangle.

As shown in FIGS. 2 and 3, the point of origin (O) of the local coordinate system is located, according to the present exemplary embodiment, in a corner of the turfed area, in this case a rectangular field (T) for playing football and/or rugby, for example. The axes Ox and Oy of this local coordinate system are parallel to the length and to the width of this field (T), respectively. This allows the field (T) to be digitized.

On this field (T), a rectangle (Q) is delimited which constitutes the area to be marked in which the pattern to be marked will be marked, and the coordinates of each vertex (X₁, Y₁), (X₂, Y₁), (X₁, Y₂) and (X₂, Y₂) of which in the local coordinate system are determined.

The rectangle (Q), that is to say the area to be marked, is partitioned into elementary cells of dimension dx and dy so as to constitute a matrix (M) of m rows and n columns with n.dx=X₂−X₁ and m.dy=Y₂−Y₁.

Regarding the pattern to be marked, it is broken down into a mosaic of pixels associated with the elementary cells of the matrix (M) and, for each elementary cell of the matrix (M), tasks to be performed by the marking means are determined according to a pixel value associated with this elementary cell in order to mark the pattern to be marked on the marking area (Q).

The set of marking means is arranged on a vehicle (V) which is guided in the local coordinate system. These marking means may consist of compressed air nozzles that make it possible to bend the leaves in one direction or another, and rollers, arranged after these nozzles in the direction of travel of the vehicle (V), to fix the orientation of the leaves.

The position of the vehicle (V) is measured and its movement is oriented on the field (T) and more particularly on the area to be marked, for example, using an optical telemetry means including a laser source emitting from the point of origin (O) of the local coordinate system and a reflecting tracking prism located on this vehicle (V).

However, when this pattern to be marked or source pattern is viewed from a target observation point (A) located high up and at a certain distance from the rectangle (Q), for example in a stand (B) at the edge of the field (T), it is viewed with a certain degree of distortion. This is for example the case when this target observation point (A) is a television camera. This distortion may make the marked pattern difficult for a television viewer to read and even make it unreadable for the viewer.

According to one embodiment of the present invention, the coordinates (X_{A}, Y_{A}, Z_{A}) of the target observation point A in the local coordinate system (O; x, y, z) are determined.

On the basis of the coordinates of the target observation point (A) and the coordinates of the area to be marked (Q), it is possible to determine the target pattern which will be marked in this marking area by the marking means. The target pattern will thus be seen from the target observation point (A) as if the source pattern were seen from a source observation point (A1) located perpendicular to the marking area and at a predefined distance therefrom.

Therefore, for each pixel of the source pattern, a solid angle for the pixel viewed from the target observation point (A) is equal to the solid angle for an area of the source pattern viewed from the source observation point (A1).

In the exemplary embodiment of the invention described above, the altimetric shape of the turfed surface is not taken into account and there is no need to determine it.

For a particularly precise image and in particular if it is desired or necessary to take the altimetric form z(x, y) into account, the pattern to be marked in order to compensate for a distortion due to the relative position of the target observation point with respect to the marking area and to the altimetric shape z(x, y) of the turfed surface is calculated on the basis of the source pattern such that the image marked on the field is exactly the same as that obtained by projecting the source pattern on the marking area using a light projection means positioned at the exact location of the target observation point.

In this embodiment of the present invention, the method therefore comprises the following additional steps:
determining the coordinates (X_{A}, Y_{A}, Z_{A}) of a target observation point (A) in the defined local coordinate system, which includes three axes;
determining the altimetric shape z(x, y) of the turf surface of the marking area;
selecting a planar source pattern;
calculating the pattern to be marked according to the source pattern in order to compensate for a distortion due to the relative position of the target observation point with respect to the marking area and to the altimetric shape z(x, y) of the turfed surface, such that this image of the pattern to be marked on the field is the same as that obtained by projecting the source pattern on the marking area using a light projection means positioned at the location of the target observation point.

In FIG. 4, three images (D₁, D₂, D₃) of the same marked pattern are shown, arranged on a field (T) at various distances from the same target observation point (A) and seen from this point at the same angle (S). As will be noted, the further the image is from the target observation point (A) the larger it is: the image (D₁), the closest to the target observation point (A), is smaller than the image (D₂), itself smaller than the image (D₃₎ which, moreover, is arranged on a surface to be marked exhibiting a change in slope.

For a less precise but much easier and much faster execution, the method according to the invention proposes various parametric models of preset altimetric shape z′(x, y) by default.

Thus, in the embodiment presented above, the true altimetric shape z(x, y), if it is not determined more precisely, is replaced by default by a choice of a horizontal plane z=0 or a parametric roof shape described by the coordinates of the ridge (by default the median longitudinal axis) and the pitch of the roof as %, or a single pitch described by its pitch as % and its pitch line.

The transformation of the source pattern into a target pattern may be performed on board the vehicle (V) or in another location: the target pattern is then transmitted to the vehicle by a suitable transmission system, to a receiver element located on this vehicle. The means receiving the target pattern, either from a device having performed the transformation on board the vehicle (V) or from the receiver element, controls the marking means and the movements of the vehicle (V) over the marking area.

Thus, according to the method of the present invention, the operation of the marking means is continually adjusted according to the previously determined matrix of the tasks to be performed for each elementary cell and it is checked that all of the elementary cells of the matrix have been treated correctly; otherwise the vehicle (V) continues to move in the rectangle (Q) and the marking means stay activated.

1. A method for reproducing a pattern to be marked on a large-sized turfed area (T) using a vehicle (V) comprising marking means, characterized in that it comprises the following steps:
defining an orthonormal local coordinate system (0; x, y, z), the two axes (x, y) being in the horizontal plane, the axis (z) being the vertical axis and the point of origin (O) being located on or near the turfed area,
determining the predefined size (dx, dy) of the elementary cells along the first axis (Ox) and along the second axis (Oy) of the local coordinate system, compatible with the size and the movement capability of the marking means so that said marking means are able to uniformly perform the marking of an elementary cell of dimension dx along the axis Ox and dy along the axis Oy without encroaching on the neighboring cells
delimiting, on the turfed area (T), a marking rectangle (R) parallel to said axes (x, y) of the coordinate system and defined by its limit coordinates between x₁ and x₂, and between y₁ and y₂, and in which said pattern will be reproduced at the desired scale on the turf and inscribed in said rectangle, reaching, without going beyond, the two sides of the rectangle parallel to the axis Oy of the coordinate system at the respective dimensions x₁ and x₂, and a first side of the rectangle parallel to the x axis at the dimension y₁, the dimension y₂ of the second side of the rectangle parallel to the axis Ox being calculated according to the height-to-width ratio of the pattern to be reproduced and such that, on the one hand, the size Y=y₂−y₁ of the sides parallel to y of said rectangle is a multiple of dy and that, on the other hand, said pattern, if it were reproduced with the exact height-to-width ratio of the pattern to be reproduced, would have a length Y=y₂−y₁+r with r smaller than dy
adjusting the height-to-width ratio of the pattern to be reproduced by disregarding the remainder r calculated previously so that the adjusted image fits exactly in the marking rectangle (Q) of surface X. Y calculated in the preceding step, the distortion due to the adjustment being very low insofar as r is smaller than dy and as dy is itself very small with respect to the length Y=y₂−y₁ of the rectangle,
partitioning the marking rectangle (Q) into a juxtaposition of elementary cells of size dx along the first axis and dy along the second axis of the local coordinate system, said elementary cells being arranged in the form of rows and columns constituting a matrix (M),
for each marking means, breaking the pattern to be marked down into a mosaic of pixels associated with the elementary cells of the matrix (M) and with the marking means in question,
determining, for each elementary cell of the matrix, the task to be performed by each marking means according to the value of the pixel associated with said elementary cell for the marking means in question and to mark the pattern to be marked on the marking area,
moving the vehicle (V) over the turfed area along a path allowing all of the elementary cells to be covered,
determining or measuring, in real time and in the local coordinate system, the position and orientation of the vehicle (V) as it moves over the turf, by means of a locating device
controlling the marking means according to the measured position and orientation of the vehicle so as to continually adjust the operation of the marking means according to the tasks to be performed in each elementary cell of the matrix (M) and perform said tasks to be performed in each elementary cell in the matrix (M).

2. The method as claimed in claim 1, characterized in that it comprises the following additional steps:
having a device for automatically controlling the vehicle and controlling it according to the measurement of the position and orientation of the vehicle so as to continually adjust the path in order to cover the marking rectangle parallel either to the axis Ox or to the axis Oy,
checking that all of the elementary cells of the matrix have been treated,
for as long as all of the elementary cells of the matrix have not been treated, controlling the vehicle to move it over the marking area.

3. The method as claimed in claim 1, characterized in that it further comprises the following steps:
determining the coordinates (X_{A}, Y_{A}, Z_{A}) of a target observation point (A) in the local coordinate system,
selecting a planar source pattern,
determining the pattern to be marked according to the source pattern in order to compensate for a distortion due to the relative position of the target observation point (A) with respect to the marking area (Q), such that an image of the pattern to be marked viewed from said target observation point (A) is substantially identical to an image of the source pattern which would be laid flat at turf level but on a tangent horizontal plane and the vertical projection of which on the turf would correspond to the limits of the marking area and which would be viewed from a source observation point located vertically in line with the center of the marking area, at a height from which the complete image is viewed at the same solid angle as from said target observation point (A).

4. The method as claimed in claim 1, characterized in that it further comprises the following steps:
determining the coordinates (X_{A}, Y_{A}, Z_{A}) of a target observation point (A) in the defined local coordinate system, which includes three axes;
determining the altimetric shape z(x, y) of the turf surface of the marking area;
selecting a planar source pattern;
calculating the pattern to be marked according to the source pattern in order to compensate for a distortion due to the relative position of the target observation point with respect to the marking area and due to the altimetric shape z(x, y) of the turfed surface, such that this image of the pattern to be marked on the field is the same as that obtained by projecting the source pattern on the marking area using a light projection means positioned at the exact location of the target observation point.

5. The method as claimed in claim 4, characterized in that the true altimetric shape z(x, y) is replaced by a simplified parametric shape z′(x, y) proposed by default from among:
a horizontal plane z=constant
a parametric roof shape described by the coordinates of the ridge and the pitch of the roof as %,
a single pitch described by its pitch as % and its pitch line.

6. The method as claimed in claim 1, characterized in that the step of measuring the position and orientation of the vehicle (V) in the local coordinate system is performed by means of an optical telemetry device including a laser source emitting from the point of origin (O) of the local coordinate system and a reflecting tracking prism located on said vehicle (V).

7. The method as claimed in claim 1, characterized in that the vehicle moves parallel either to the axis Ox or the axis Oy.

8. The method as claimed in claim 1, characterized in that the marking means consist of compressed air nozzles that make it possible to bend the leaves or blades of grass in one direction or another, and of rollers, arranged after said nozzles in the direction of travel of the vehicle (V), to fix the orientation of the leaves or blades of grass.
